(19) United States
(12) Patent Application Publication
(10) Pub. No.: US 2025/0340440 A1
(43) Pub. Date: Nov. 6, 2025

(54) GRAPHITE ROASTING AND PURIFICATION FOR LI-ION BATTERIES

(71) Applicant: Ascend Elements, Inc., Westborough, MA (US)

(72) Inventor: Yilun Tang, Westborough, MA (US)

(21) Appl. No.: 18/653,479

(22) Filed: May 2, 2024

(51) Int. Cl. C01B 32/205; H01M 10/54

(52) U.S. Cl. CPC C01B 32/205; H01M 10/54; C01P 2002/85; C01P 2006/40; C01P 2006/80

(57) ABSTRACT

A purification process for recycled graphite for use as anode material in Li-ion batteries includes heating or roasting graphite from a recycling stream for removing impurities such as PVDF (polyvinylidene fluoride) and other fluorides. A precipitate comprising graphite results from a suitable process such as acid leaching of black mass from a battery recycling stream. The acid leach separates cathode material metals, leaving a graphite rich precipitate of anode materials. Impurities resulting from binder and other materials tend to remain in the precipitate. A roasting process is used to heat the precipitate for removal of contaminants such as fluorides resulting from PVDF residues, without burning or removing the graphite. The result is a highly pure graphite suitable for use in anode material in a recycled battery.

### BACKGROUND

Lithium-ion (Li-ion) batteries are a preferred chemistry for secondary (rechargeable) batteries in high discharge applications such as electrical vehicles (EVs) where electric motors are called upon for rapid acceleration. Li-ion batteries include a charge material, conductive powder, and binder applied to or deposited on a current collector, typically a planar sheet of copper or aluminum. The charge material includes anode material, typically graphite or carbon, and cathode material, which includes a predetermined ratio of metals such as lithium, nickel, manganese, cobalt, aluminum, iron and phosphorous, defining a so-called “battery chemistry” of the Li-ion cells. The preferred battery chemistry varies between vendors and applications, and recycling efforts of Li-ion batteries typically adhere to a prescribed molar ratio of the battery chemistry in recycled charge material products. A purity in the mass of constituent products is highly relevant to the quality and performance of the recycled cells, often relying on so-called “battery grade” materials, implying at least a 99.5% purity.

### SUMMARY

A purification process for recovering high purity recycled graphite for use as anode material in new Li-ion batteries includes heat treating or roasting graphite obtained from a recycling stream for removing impurities such as PVDF (polyvinylidene fluoride) and other fluorides. The graphite source can result from a suitable process including acid leaching of black mass from a battery recycling stream. The acid leach separates cathode material metals from the black mass, leaving a graphite rich precipitate of anode materials. Impurities resulting from binder and other materials tend to remain in the precipitate. In a roasting process, the precipitate is heated for removal of contaminants such as fluorides such as PVDF residues, without burning, decomposing, or otherwise removing the graphite. The result is a highly pure graphite suitable for use in anode material in a recycled battery.

Configurations herein are based, in part, on the observation that conventional approaches to battery recycling result in substantial impurities remaining in graphite precipitate for anode material recycling. For example, aluminum oxide impurities may be present resulting from residual binder, electrolyte, current collectors, or other battery components. Unfortunately, conventional recycling approaches suffer from the shortcoming that some impurities, particularly PVDF and other fluorides, may also be present in some formulations and elude the purification processes. Accordingly, configurations herein substantially overcome the shortcomings of conventional approaches by providing a roasting process in which a shredded and leached BM precipitate is heated to a temperature that removes or burns away fluoride-containing impurities such as PVDF but leaves the graphite substantially intact. The result is a highly pure (>99.9%) graphite suitable for anode material in a recycled battery.

In further detail, in a battery recycling environment for producing purified graphite for use as a battery anode material, recycling includes leaching a black mass of exhausted lithium-ion batteries to obtain a leach solution and a precipitate. The leach solution includes the metal salts of the cathode material, leaving the remainder as an undissolved precipitate including substantial proportions of graphite and/or other carbon forms used for the anode material. Heat treating (also referred to herein as roasting) of the precipitate at a temperature selected based on removal of fluorides, while retaining graphite, yields purified graphite. Washing of the purified graphite, optionally with dilute acid, generates battery grade anode material for use in a recycled Li-ion battery.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context diagram of a recycling environment suitable for use with configurations herein;

FIG. 2 is a flowchart of a recycling process as disclosed herein;

FIG. 3 shows thermogravimetric analysis of the precipitate, produced after leaching and prior to the roasting process of FIG. 2;

FIG. 4 shows thermogravimetric analysis of the precipitate after the roasting process of FIG. 2;

FIG. 5A shows energy dispersive spectroscopy (EDS) results before the roasting process;

FIG. 5B shows EDS results after the roasting process; and

FIGS. 6 and 7 depict analysis of samples based on the roasting process of FIGS. 1 and 2.

### DETAILED DESCRIPTION

The highly touted advantages of electric vehicles (EVs) over fossil fuel energy sources presents a less-publicized challenge of disposal of EV batteries following an EV's useful life. The charge material in EVs that stores and releases the electrical energy degrades over time, and the capacity to store electrical energy diminishes. Add to this the premature tenure of vehicles removed from service due to collision or vehicle defects. The quantity of charge materials in the spent (exhausted) end-of-life batteries generates a substantial volume of potentially environmentally hazardous material. Recycling of the Li-ion batteries typically used in EVs mitigates both the need to mine new raw material and the disposal of the end of life, spent EV batteries.

The electrochemical reactions occurring in a battery form a current flow between positive and negative terminals of the battery. Any electrical source provides useful power through a directed electron flow between the positive and negative terminals, or “poles” of the source, whether battery or grid based. While Li-ion batteries improve the charge capacity and discharge rate over conventional batteries, the electric principles remain the same. The electrical capacity of a battery, as well as the speed of charging and discharging, is determined by the cathode and anode material in the battery.

The modern increase in popularity of electric and hybrid vehicles (EV/HV) generates a large volume of spent Li-ion batteries including charge material such as NMC (Ni, Mn, Co) cathode material, and anode material including graphite and similar carbon forms. Recycling processes for NMC charge material often include leaching of the spent NMC charge material, sometimes with metal ratio adjustment using control (virgin) stocks of Ni, Mn, and Co. Recycling of the cathode materials is financially attractive due to the expense of obtaining the charge material metals, particularly cobalt and nickel, in the cathode material. Anode materials however, once dismissed as inexpensive and commonplace, are emerging as a feasible candidate for recycling.

A particular process for recycling anode materials is disclosed in U.S. patent application Ser. No. 18/114,488, filed Feb. 27, 2023, entitled “RECYCLED GRAPHITE FOR LI-ION BATTERIES.” Graphite recycling is particularly beneficial when sourced from a cathode recycling stream such as that disclosed in U.S. Pat. No. 11,769,916, filed Oct. 12, 2022, entitled “METHOD AND APPARATUS FOR RECYCLING LITHIUM-ION BATTERIES,” both incorporated herein by reference. The cathode recycling process removes substantially all of the cathode material metals, such as Ni, Mn and Co, leaving a graphite rich precipitate for anode recycling.

A paramount challenge in recycling Li-ion battery packs is the undetermined history of the batteries, particularly the battery chemistry or composition of anode and cathode materials. Batteries in the recycling stream are often organized according to parameters such as age, manufacturer, and vehicle model. However, anomalies and impurities in the recycling source cannot be avoided. Cathode material variances and impurities can be accommodated by the approach in the application cited above. However, some batteries, particularly those emanating from older and first generation EVs, present challenges from fluoride contaminants such as PVDF. Accordingly, there is a need for a process to recycle graphite anode materials containing such fluoride-containing components. Configurations herein are particularly effective at removal of fluoride contaminants, achieving 99.9% purity of recycled graphite for anode material for use in recycled batteries.

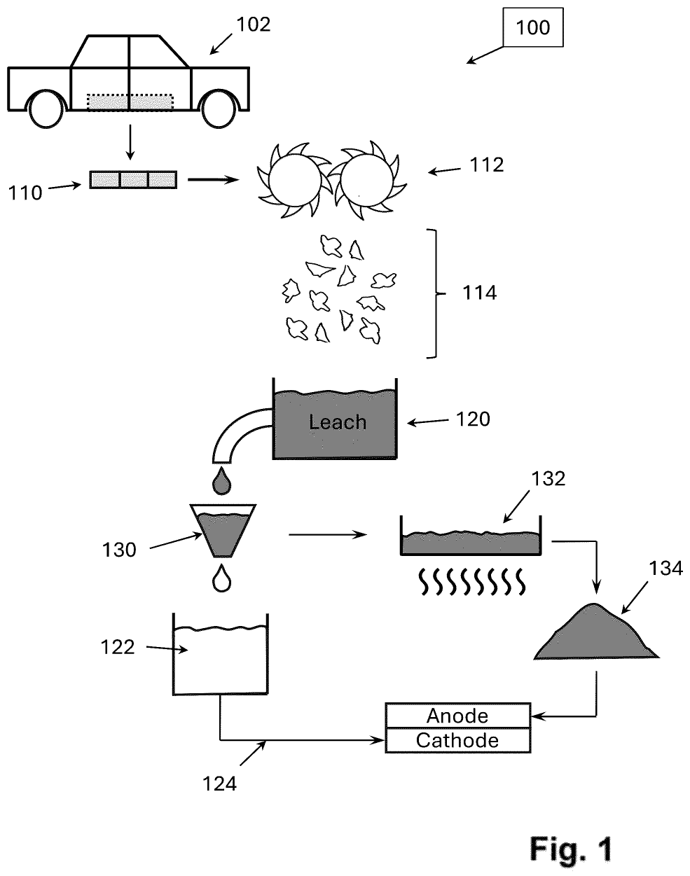

FIG. 1 is a context diagram of a recycling environment suitable for use with configurations herein. Referring to FIG. 1, in a battery recycling environment 100, Li-ion batteries for recycling 110 form a recycling stream, often sourced from end of service EVs 102. An agitation device 112 physically crushes, shreds, or grinds the batteries into a granular assortment 114 of comingled battery materials including anode materials, cathode materials, current collectors, and casing materials, often referred to as a black mass. Typically, extraction of the granular assortment forms a leach solution 120 from leaching of the cathode material metals. The leach solution 120 passes through a filter that separates a precipitate 130 of granular solids including graphite and a coprecipitation solution 122 of dissolved cathode material metals. In an example configuration, directing the leach solution to an NMC coprecipitation process provides a complementary recycling for both cathode and anode material, as disclosed in the applications cited above.

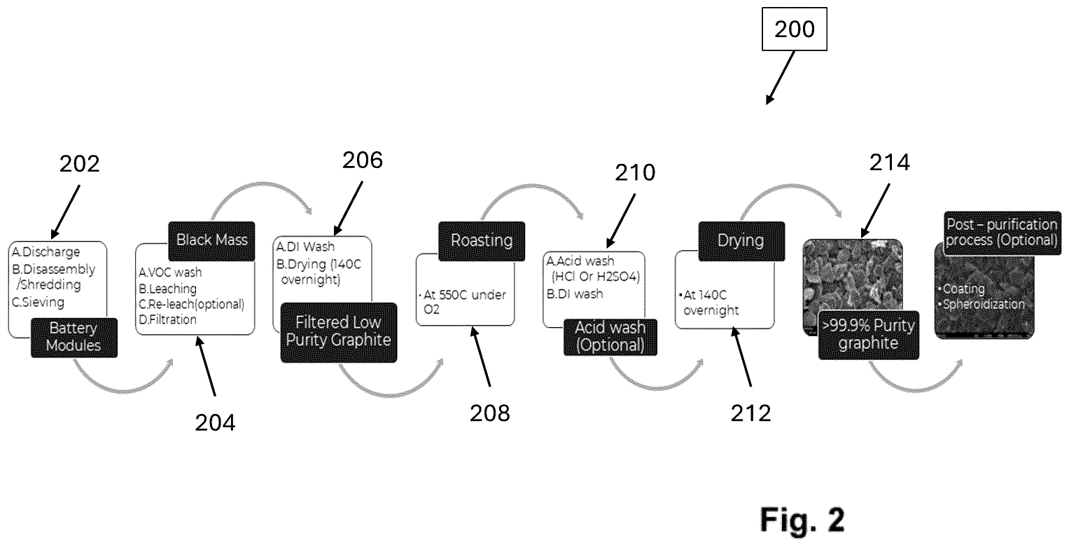

The precipitate 130 is rich in graphite, as described above, however typically has contaminants such as PVDF or other fluorides. A roasting process including oven 132 can be used to remove the fluoride contaminants, as described below such as in FIG. 2, to yield substantially pure graphite. The purity of graphite 134 from this process has been found to be at least 99.9% and therefore can be used for forming a recycled anode material for a new battery. Similarly, recycled cathode materials 124 resulting from a coprecipitation process can be used to form a recycled cathode 150 for use in a new recycled battery.

FIG. 2 is a flowchart of an example recycling process 200 as disclosed herein. Referring to FIGS. 1 and 2, the disclosed method of producing a purified graphite from a battery recycling stream includes receiving the black mass as the granular assortment 114 resulting from physical agitation (such as shredding) and dismantling/disassembly of end-of-life batteries 110, as shown at step 202. Discharge of the batteries may also be preferable in order to avoid a sudden release of any excess residual electrical energy remaining in the battery cells. The black mass is preferably received from a recycling stream including Li based cathode materials and anode materials. An aqueous solution of sulfuric acid or another suitable acid is added to the black mass of exhausted lithium-ion batteries to obtain the leach solution 120 and the precipitate 130, which is substantially graphite yet still containing impurities, as depicted at step 204. Multiple leaching iterations of the black mass may occur. The precipitate 130 is washed and dried, as depicted at step 206.

The precipitate 130 comprising low purity graphite is roasted at a temperature selected based on removal of fluoride impurities while retaining graphite to obtain purified graphite, as shown at step 208. Roasting at the selected temperature occurs for at least 30 minutes and may be preceded by a temperature ramp-up to attain the selected temperature. An oxygen-containing environment is preferred. The temperature is selected to be above a temperature that removes or decomposes the fluoride impurities and below a temperature that consumes or degrades the graphite. For example, PVDF will begin to decompose and burn off at approximately 450° C., while graphite will begin to burn off at or above 650° C. in an oxygen-containing environment. An optimal temperature for impurity removal without degrading the graphite is between 500° C. and 550° C. This is discussed in more detail below. Ambient air may provide sufficient oxygen. However, a gaseous supply may of course be provided. Roasting continues for a sufficient time to remove substantially all fluoride impurities.

The roasted, purified graphite 134 is washed for generating use as anode material in a recycled battery, as depicted at step 210. Alternatively, the purified graphite may be washed in hydrochloric acid, sulfuric acid, or another suitable acid. The washed, purified graphite is then dried at a temperature of at least 100° C., overnight or for around 6-8 hours, as shown at step 212. The purified graphite has a purity of at least 99.5%, and preferably a purity of 99.9% or greater, as shown at step 214.

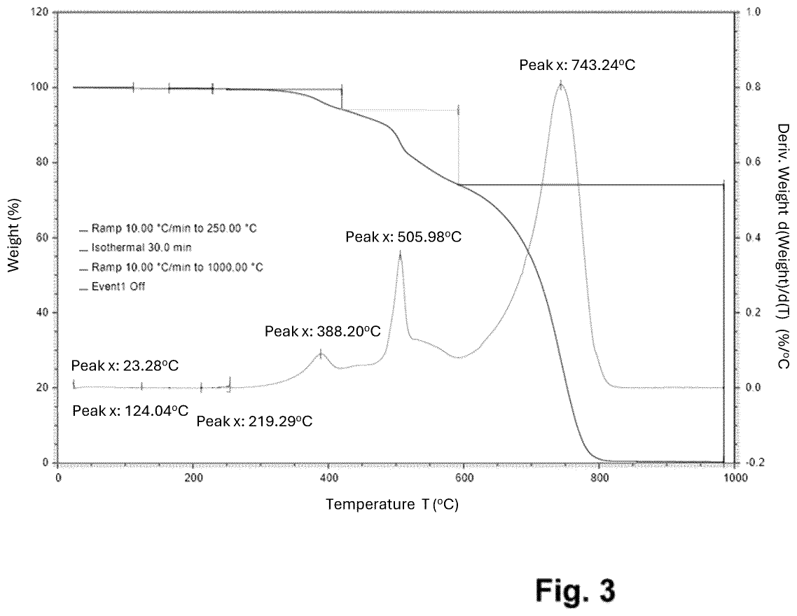

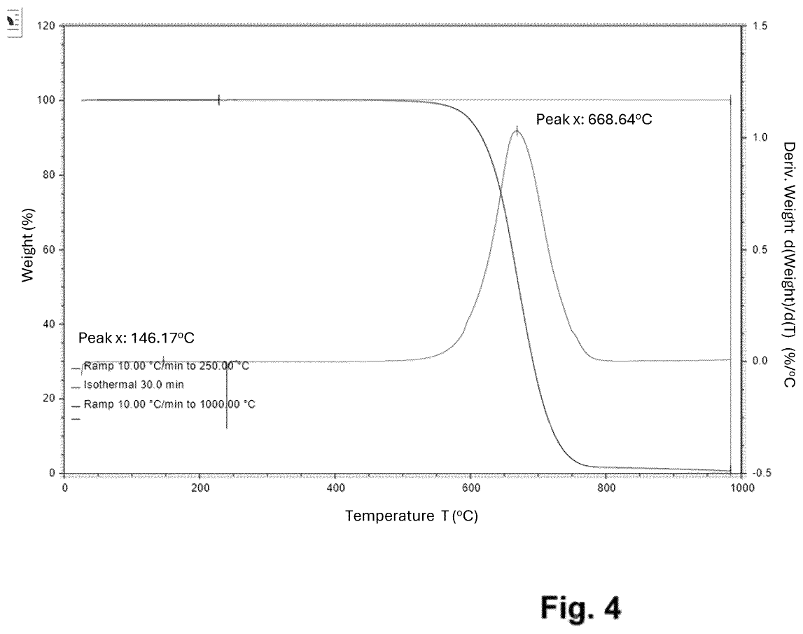

FIG. 3 shows a thermogravimetric analysis of precipitate 130. As can be seen, as temperature increases, several peaks result indicating weight loss at these corresponding temperatures. Elemental analysis showed these to be primarily from fluoride-containing impurities. Thus, between about 100° C. and 600° C., impurities of the precipitate, including fluoride impurities such as PVDF, decompose, reacting with the oxygen-containing atmosphere. Surprisingly, it was found that the majority of the weight loss from decomposition of the graphite of the precipitate occurred at temperatures starting at or near 600° C. Thus, roasting the precipitate at a temperature in a range that is below the decomposition temperature of graphite but above the decomposition temperature of the fluoride-containing impurities would remove the impurities without significant loss of carbonaceous material graphite, resulting in a substantially pure graphite. This is confirmed by the TGA shown in FIG. 4 of a purified graphite after roasting, showing no fluoride impurities.

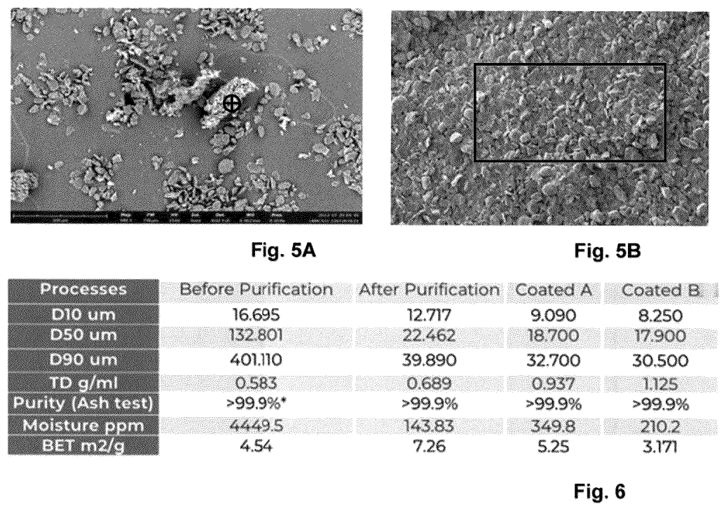

FIG. 5A shows EDS results before the roasting process, and FIG. 5B shows EDS results after the roasting process. Prior to roasting, the precipitate material contains over 11% fluorides, as shown in Table I:

TABLE I

| Element | Name | Atomic Conc. | Weight Concentration |
|---|---|---|---|
| C | Carbon | 88.393% | 82.800% |
| F | Fluorine | 11.607% | 17.200% |

Following roasting, the fluorides have burned off/reacted, leaving nearly pure carbon, as shown in Table II. This confirms the removal of PVDF, being removed by the use of a roasting temperature range of 500° C. and 550° C.

TABLE II

| Element | Name | Atomic Conc. | Weight Concentration |
|---|---|---|---|
| C | Carbon | 100.0% | 100.0% |

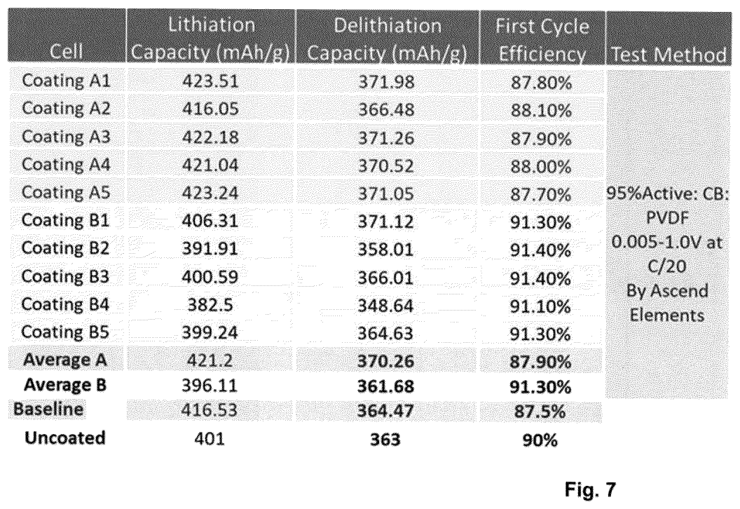

FIGS. 6 and 7 depict analysis of samples based on the roasting process of FIGS. 1 and 2. FIG. 6 shows purity (ash) tests for two types of samples having fluoride-based coatings-coating A and coating B. FIG. 7 shows 5 samples each having coating A and coating B.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of producing a purified graphite from a battery recycling stream comprising:
leaching a black mass of exhausted lithium-ion batteries to obtain a leach solution and a precipitate comprising graphite and fluoride impurities;
roasting the precipitate at a temperature selected based on removal of the fluoride impurities while retaining graphite to obtain purified graphite; and
washing the purified graphite for generating anode material for use in a recycled battery.

2. The method of claim 1 wherein the selected temperature is above a temperature that decomposes the fluoride impurities and below a temperature that decomposes the graphite.

3. The method of claim 2 wherein the selected temperature is between 500° C. and 550° C.

4. The method of claim 2 wherein the selected temperature is between 450° C. and 650° C.

5. The method of claim 1, wherein the precipitate is roasted in an O₂ environment.

6. The method of claim 1, wherein the black mass comprises cathode materials and anode materials from the exhausted lithium-ion batteries.

7. The method of claim 6 wherein the cathode materials include Ni, Mn, and Co.

8. The method of claim 1 further comprising agitating the exhausted Li-ion batteries for generating the black mass.

9. The method of claim 1 further comprising directing the leach solution to an NMC coprecipitation process.

10. The method of claim 1 wherein the purified graphite has a purity of 99.5%.

11. The method of claim 1 wherein the purified graphite has a purity of 99.9%.

12. The method of claim 1 further comprising:
washing the purified graphite in an aqueous acidic solution; and
drying the washed, purified graphite at a temperature of at least 100° C.

13. The method of claim 12, wherein the acid is hydrochloric acid or sulfuric acid.

14. The method of claim 1, wherein the precipitate is roasted at the selected temperature for at least 30 minutes.

15. The method of claim 1, wherein the selected temperature is reached by a gradual temperature increase.

16. The method of claim 15, wherein the gradual temperature increase is about 10° C./min.

17. The method of claim 1, wherein the fluoride impurities comprise PVDF.
